(19) United States
(12) Patent Application Publication
(10) Pub. No.: US 2015/0355064 A1
(43) Pub. Date: Dec. 10, 2015

(54) Method Of Screening Or Selection Aluminum Sheets For A Manufacturing Process

(71) Applicant: FORD GLOBAL TECHNOLOGIES, LLC, Dearborn, MI (US)

(72) Inventors: Laurent Bernard Chappuis, Grosse Ile, MI (US); Peter A. Friedman, Ann Arbor, MI (US); Christopher Joseph Mracna, JR., Huntington Woods, MI (US); Jochen Schenk, Bonn NRW (DE)

(73) Assignee: FORD GLOBAL TECHNOLOGIES, LLC, Dearborn, MI (US)

(21) Appl. No.: 14/295,666

(22) Filed: Jun. 4, 2014

(51) Int. Cl. G01N 3/40; B21D 22/02; C22F 1/04

(52) U.S. Cl. CPC G01N 3/40; C22F 1/04; B21D 22/02

(57) ABSTRACT

A method is provided for selecting a heat treated aluminum sheet for use in a manufacturing process. The aluminum sheet is tested for an initial strength value before being stored for a period of time. A subsequent strength value of the aluminum sheet is calculated after the period of time has elapsed. The aluminum sheet is selected for use in the manufacturing process if the subsequent strength value is within a predetermined range.

### TECHNICAL FIELD

The present disclosure relates to the processing of aluminum sheets used in manufacturing processes.

### BACKGROUND

Aluminum sheets that are subjected to a heat treating process may continue to harden over time, in a process known as age hardening. The yield strength of an aluminum sheet may increase due to age hardening and eventually exceed the acceptable tolerance range requirement for yield strength.

### SUMMARY

In one aspect of the disclosure, a method is provided for selecting a heat treated aluminum sheet for use in a manufacturing process. The aluminum sheet is tested for an initial strength value before being stored for a period of time. A subsequent strength value of the aluminum sheet is calculated after the period of time has elapsed. The aluminum sheet is selected for use in the manufacturing process if the subsequent strength value is within a predetermined range.

In another aspect of the disclosure, a method of establishing a processing window for a heat treated aluminum sheet for use in a manufacturing process is provided. An initial strength value of the aluminum sheet is obtained and a graph of subsequent strength values of the aluminum sheet is plotted over a period of time by applying an age hardening rate of change to the initial strength value. A subsequent strength value is then compared to an upper strength limit. The aluminum sheet is then processed in the manufacturing process if the subsequent strength value is less than the upper strength limit.

In yet another aspect of the disclosure, a method for screening a heat treated aluminum sheet for a manufacturing process is provided. An initial strength value of the aluminum sheet is obtained and a subsequent strength value of the aluminum sheet is then calculated after a period of time. The aluminum sheet is then rejected for use in the manufacturing process if the subsequent value of the aluminum sheet is outside a predetermined range.

### BRIEF DESCRIPTION OF THE DRAWINGS

FIG. 1 is a flowchart illustrating a method of selecting or screening heat treated aluminum for use in a manufacturing process;

FIG. 2 is a flowchart illustrating a method of establishing a processing window for a heat treated aluminum sheet prior to use in a manufacturing process;

FIG. 3 illustrates the time dependent strength properties of aluminum, due to age hardening, relative to the strength tolerances of aluminum required for manufacturing; and

FIG. 4 is alternative embodiment illustrating the time dependent strength properties of aluminum, due an age hardening, relative to the strength tolerances of aluminum required for manufacturing.

### DETAILED DESCRIPTION

The illustrated embodiments are disclosed with reference to the drawings. However, it is to be understood that the disclosed embodiments are intended to be merely examples that may be embodied in various and alternative forms. The figures are not necessarily to scale and some features may be exaggerated or minimized to show details of particular components. The specific structural and functional details disclosed are not to be interpreted as limiting, but as a representative basis for teaching one skilled in the art how to practice the disclosed concepts.

Many aluminum alloys continue to harden at room temperatures post heat treatment in a process called age hardening. Age hardening may impact manufacturing if the strength of the aluminum exceeds the yield strength tolerance ranges for a manufacturing process. There is a need for a method for selecting, screening, or utilizing aluminum sheet in a manufacturing process prior to the aluminum sheet exceeding the yield strength tolerance range for the manufacturing process due to the age hardening.

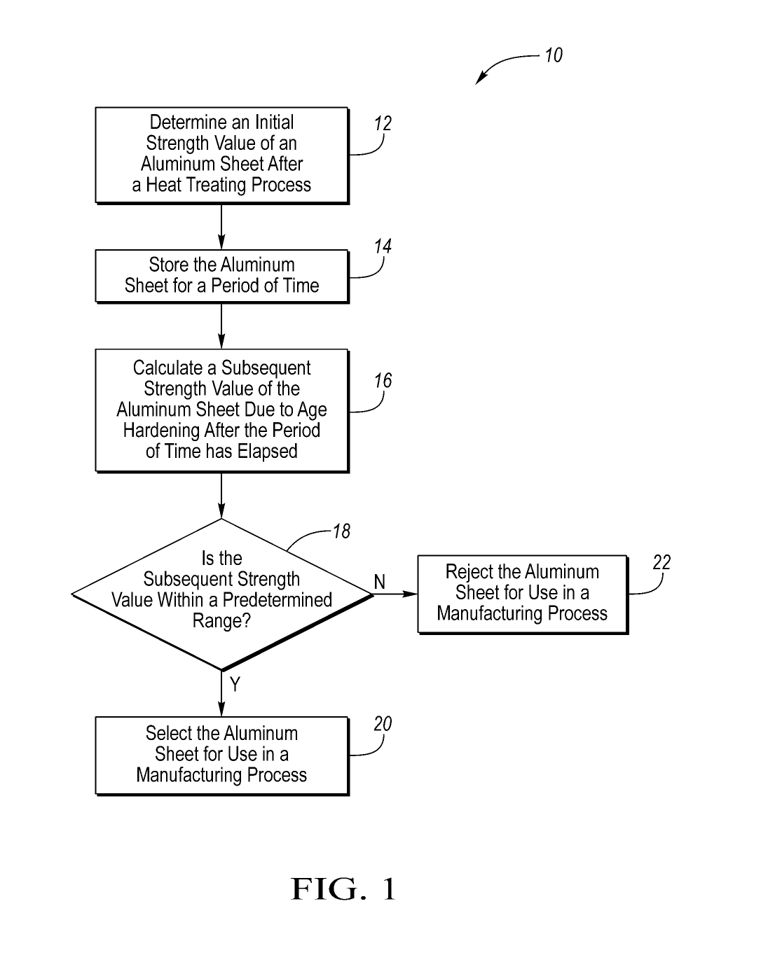

Referring to FIG. 1, a method 10 of selecting or screening a heat treated aluminum sheet for use in a manufacturing process is illustrated. At step 12 an initial strength value of the aluminum sheet is determined after a heat treating process. The initial strength value may be determined by using any standard strength test in industry, such as the ASTM Standard B557 test—“Standard Test Methods for Tension Testing Wrought and Cast Aluminum Products,” that is utilized to measure yield stress. The ASTM Standard B918 test—“Standard Practice for Heat Treatment of Wrought Aluminum Alloys” may be utilized to assess the ability of the material to gain strength by heat treatment. The initial strength value is determined within a predetermined time period after heat treating. The predetermined time period is typically less than 7 days.

The aluminum sheet is stored for a period of time at step 14. A subsequent strength value of the aluminum sheet is calculated at step 16 based upon the age hardening properties of aluminum after the period of time at step 14 has elapsed. The initial and subsequent strength values may correspond to a yield strength value in the aluminum sheet.

The subsequent strength value of the aluminum sheet is determined at step 18. The aluminum sheet is selected for use in a manufacturing process at step 20 if the subsequent strength value is within the predetermined range. The aluminum sheet is rejected for use in a manufacturing process at step 22 if the subsequent strength value is not within the predetermined range.

The manufacturing process in steps 20 and 22 may be any manufacturing process that includes shape forming or machining of the aluminum sheet. The manufacturing processes that may be utilized include, but are not limited to, stamping, hydroforming, drilling, milling, cutting, grinding, bending, riveting, and the like. The aluminum sheet used in the method 10 may be any type of heat-treatable aluminum alloy including 2000, 6000, and 7000 series aluminum alloys.

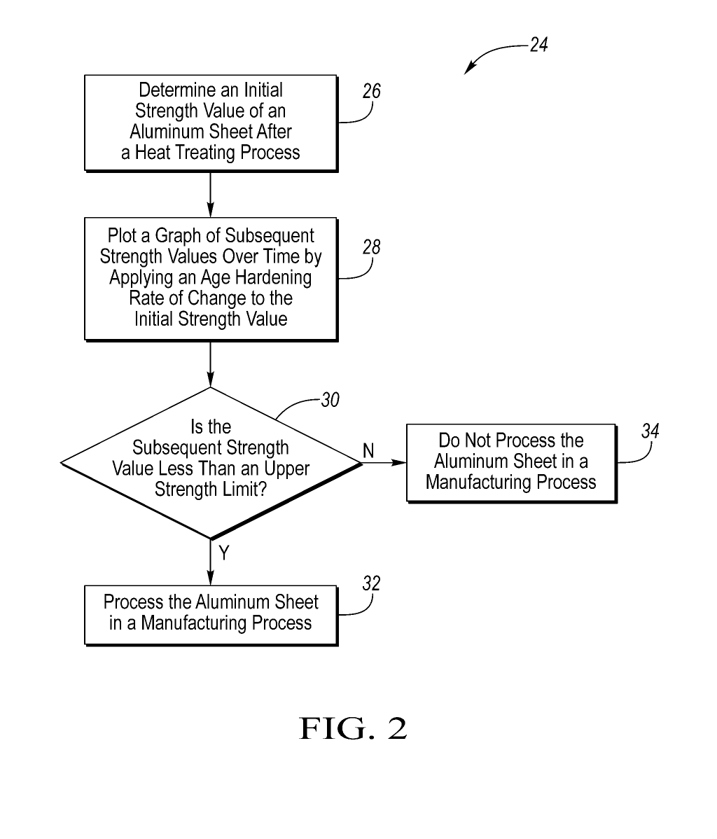

Referring to FIG. 2, a method 24 of establishing a processing window for a heat treated aluminum sheet prior to use in a manufacturing process is illustrated. At step 26 an initial strength value of the aluminum sheet is determined after a heat treating process. The initial strength value and the ability of the material to gain strength by heat treatment may be determined by using any standard strength test in industry, such as the tests mentioned above. The initial strength value is determined within a predetermined time period after heat treating. The predetermined time period is typically less than 7 days.

The subsequent strength values of the aluminum sheet are plotted over time in a graph at step 28 by applying an age hardening rate of change to the initial strength value. The initial and subsequent strength values may correspond to a yield strength value in the aluminum sheet.

The subsequent strength value of the aluminum sheet is compared to an upper limit at step 30. The aluminum sheet is selected for use in a manufacturing process at step 32 if the subsequent strength value is less than an upper strength limit. The aluminum sheet is rejected for use in a manufacturing process at step 34 if the subsequent strength value is not less than an upper strength limit.

The manufacturing process in steps 32 and 34 may be any of the manufacturing processes referred to above that may utilized in steps 20 and 22. The aluminum sheet used in method 24 may be any type of heat-treatable aluminum alloy referred to above that may be utilized in method 10.

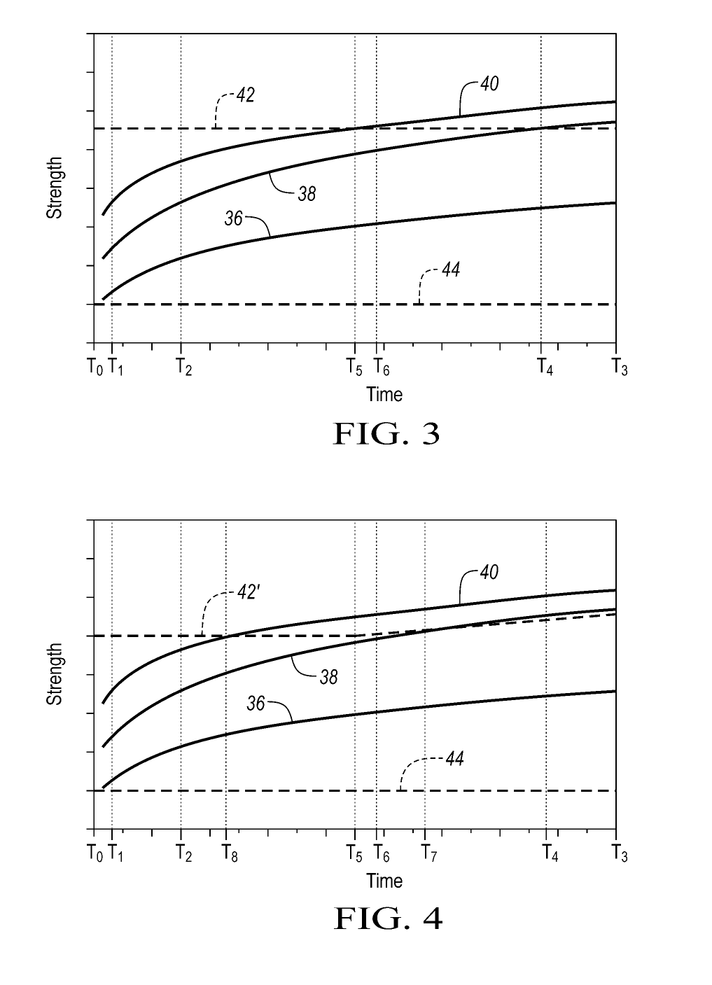

Referring to FIG. 3, time dependent strength properties of aluminum, due to age hardening, relative to the strength tolerances of aluminum required for a manufacturing process is illustrated. An aluminum sheet has a “birthday” on the day the aluminum sheet is heat treated. The aluminum sheet “birthday” corresponds to time T₀ in FIG. 1. The aluminum sheet begins to age harden immediately after being heat treated at time T₀ and is tested for initial an initial strength value at time T₁. The aluminum sheet is tested at time T₁ within 7 days of being heat treated. A graph of strength values is plotted over time by applying a known age hardening rate once an initial strength value is calculated. Aluminum sheet age hardening rates are more rapid immediately after the heat treating process, but begin to level out to an almost linear rate at time T₂. For 6000 series aluminum the rate of age hardening slows and levels out at approximately 30 days after heat treating.

Three lines 36, 38, 40 are plotted in FIG. 3 that illustrate the calculated yield strength values of three different examples of aluminum sheets over time due to age hardening. The aluminum sheets depicted by the lines 36, 38, 40 will remain acceptable for use in a manufacturing process during time periods that the strength values of the aluminum sheets remain within a predetermined range depicted by an upper strength limit 42 and a lower strength limit 44. The upper limit may range from 125 MPa to 195 MPa and the lower limit may range from 70 MPa to 100 MPa.

There also may be a maximum shelf life, corresponding to time T₃, where the aluminum sheets will be rejected regardless of the strength values beyond that time T₃. The maximum shelf life may range from 150 to 270 days, but preferably is 180 days.

Line 36 corresponds to an aluminum sheet that will not be rejected for use in a manufacturing process at any time unless there is a maximum shelf life at time T₃.

Line 38 corresponds to an aluminum sheet that will be acceptable for use in a manufacturing process during the period between time T₀ and time T₄ when the strength of the aluminum sheet remains below the upper strength limit 42, but will not be acceptable for use in a manufacturing process after time T₄. Time T₄ corresponding to a time after the aluminum sheet depicted by line 38 exceeds the upper limit 42.

Line 40 corresponds to an aluminum sheet that will be acceptable for use in a manufacturing process during the period between time T₀ and time T₅ when the strength of the aluminum sheet remains below the upper strength limit 42, but will not be acceptable for use in a manufacturing process after time T₅. Time T₅ corresponding to a time after the aluminum sheet depicted by line 40 exceeds the upper limit 42.

With continued reference to FIG. 3, a customary usage period may correspond to a time period for using an aluminum sheet in a manufacturing process. It may be desirable to reject the aluminum sheet for use in the manufacturing process if the aluminum sheet does not remain within the upper and lower strength limits 42, 44 during the entire customary usage period. For example, the time period between the times T₂ and T₆ may refer to a customary usage period. The aluminum sheets corresponding to the lines 36 and 38 remain between the upper and lower strength limits 42, 44 between times T₂ and T₆ and are acceptable for use in the manufacturing process during the customary usage period. The aluminum sheet corresponding to line 40 however will be rejected for use in a manufacturing process because it exceeds the upper limit 42 at time T₅, during the customary usage period between time T₂ and T₆. The customary usage period may have a range of anywhere between 5 and 180 days, but is preferably between 30 and 90 days. Although a customary usage period may be desirable, it is not a requirement.

It also may be desirable to allow an aluminum sheet to age harden for a minimum period of time prior to use in a manufacturing process. The minimum period may be as low as 10 days, but is preferably 30 days. Although allowing an aluminum sheet a minimum period of time to age harden prior to use may be desirable, it is not a requirement.

Referring to FIG. 4, an alternative upper strength limit 42′ is depicted. The alternative upper strength limit 42′ is set a constant value for a first portion of a potential storage period of a heat treated aluminum sheet and ramps up to a higher strength value at a second portion of a potential storage period for the heat treated aluminum sheet. The first potential storage period is depicted between times T₀ and T₅, and the second potential storage period is depicted between times T₅ and T₃. The aluminum sheet corresponding to line 38 would be rejected at time T₇ for use in the manufacturing process and the aluminum sheet corresponding to line 40 will be rejected at time T₈ for use in the manufacturing process under the alternative upper strength limit 42′. The alternative upper strength limit 42′ may have a value that ranges between 125 MPa and 195 MPa.

The embodiments described above are specific examples that do not describe all possible forms of the disclosure. The features of the illustrated embodiments may be combined to form further embodiments of the disclosed concepts. The words used in the specification are words of description rather than limitation. The scope of the following claims is broader than the specifically disclosed embodiments and also includes modifications of the illustrated embodiments.

What is claimed is:

1. A method of selecting a heat treated aluminum sheet for a manufacturing process comprising:
testing a sheet to obtain an initial strength value;
storing the aluminum sheet for a period of time;
calculating a subsequent strength value of the sheet after the period of time; and
selecting the sheet for use in the manufacturing process if the subsequent strength value of the sheet is within a predetermined range.

2. The method of claim 1, wherein the step of testing the sheet for an initial strength value is conducted within a predetermined period after a heat treating process.

3. The method of claim 1, wherein the step of calculating the subsequent strength value corresponds to a yield strength value of the aluminum sheet.

4. The method of claim 3, wherein the predetermined range of the subsequent strength value is a yield strength value that ranges between 90 MPa and 185 MPa.

5. The method of claim 1, wherein the step of calculating a subsequent strength of an aluminum sheet is based upon age hardening properties of heat treated aluminum.

6. The method of claim 1, wherein the manufacturing process is a stamping process.

7. The method of claim 1, wherein the aluminum sheet is 6000 series aluminum.

8. A method of establishing a processing window for a heat treated aluminum sheet prior to use in a manufacturing process comprising:
obtaining an initial strength value of the aluminum sheet;
plotting a graph of subsequent strength values over a period of time by applying an age hardening rate of change to the initial strength value;
comparing a subsequent strength value on the graph to an upper strength limit; and
processing the aluminum sheet in the manufacturing process if the subsequent strength value is less than the upper strength limit.

9. The method of claim 8, wherein the initial strength of the aluminum sheet is obtained by a strength test within a predetermined period after the heat treating process.

10. The method of claim 8, wherein the step of plotting a graph of subsequent strength values over a period of time corresponds to a yield strength value of the aluminum sheet.

11. The method of claim 10, wherein the upper strength limit value is a yield strength that ranges between is set between 125 MPa and 195 MPa.

12. The method of claim 8, wherein the aluminum sheet is rejected for use in a manufacturing process if the subsequent strength value of the aluminum sheet exceeds the upper strength limit at any time between 30 and 90 days after the heat treating process.

13. The method of claim 8, wherein the aluminum sheet is allowed to age harden for at least 30 days, after the heat treating process, prior to processing the aluminum sheet in the manufacturing process.

14. The method of claim 8, wherein the manufacturing process is a stamping process.

15. The method of claim 8, wherein the aluminum sheet is 6000 series aluminum.

16. A method for screening a heat treated aluminum sheet for a manufacturing process comprising:
obtaining an initial strength value of the aluminum sheet;
calculating a subsequent strength value of the aluminum sheet after a period of time; and
rejecting the aluminum sheet for use in a manufacturing process if the subsequent strength value of the aluminum sheet is outside a predetermined range.

17. The method of claim 16, wherein the initial strength of the aluminum sheet is obtained by a strength test within a predetermined period after the heat treating process.

18. The method of claim 17, wherein the step of calculating the subsequent strength value corresponds to a yield strength value of the aluminum sheet.

19. The method of claim 18, wherein an upper limit of the predetermined range is set at a constant strength value for a first portion of a potential storage period and ramps up to a higher strength value during a second portion of the potential storage period.

20. The method of claim 19, wherein the upper limit of the predetermined range is set at a strength value between 125 MPa and 185 MPa during the first portion of the potential storage period and ramps up to a value during the second portion of the potential storage period that is 5 MPa to 10 MPa more than upper limit during the first portion of the potential storage period.
